(19) United States
(12) Patent Application Publication
(10) Pub. No.: US 2006/0103756 A1
(43) Pub. Date: May 18, 2006

(54) Lens barrel and electronic device

(75) Inventor: Toshikatsu Shiozaki, Tokyo (JP)

Correspondence Address: OSTROLENK FABER GERB & SOFFEN, 1180 AVENUE OF THE AMERICAS, NEW YORK, NY, 100368403, US

(73) Assignee: Olympus Corporation

(21) Appl. No.: 11/266,945

(22) Filed: Nov. 4, 2005

(30) Foreign Application Priority Data
Nov. 17, 2004 (JP) 2004-333616

(51) Int. Cl. H04N 5/225

(52) U.S. Cl. 348/360

(57) ABSTRACT

In an electronic device having a movable member being capable of moving therein and an electric wire member disposed therein and deformed in association with the movement of the movable member, a movable guiding member being capable of moving independently of other members for guiding the electric wire member in association with the movement of the movable member is provided. Accordingly, deformation of the electric wire member in association with the movement of the movable member can be controlled by being guided by the movable guiding member. An example of the electronic device to which the present invention is applied is a lens barrel.

### CROSS-REFERENCE TO RELATED APPLICATION

This application is based upon and claims the benefit of priority from prior Japanese Patent Application No. 2004-333616, filed Nov. 17, 2004, the entire contents of which are incorporated herein by reference.

### BACKGROUND OF THE INVENTION

1. Field of the Invention

The present invention relates to a lens barrel and an electronic device. In particular, the invention relates to a lens barrel and an electronic device including a flexible printed circuit board for electrical connection disposed therein.

2. Description of the Related Art

An electronic device such as a camera having a zoom lens barrel which can change a focal distance by moving a lens barrel back and forth is known in the related art. An example of a camera of this type will be described below.

For example, a camera having a zoom lens barrel provided with a controlled unit and a flexible printed circuit board (hereinafter, referred to as FPC) for electrically connecting the controlled unit and a circuit board in a camera body is known.

The FPC described above is installed so as to move back and forth along a back-and-forth movement of a lens frame, so that reception of various signals from the circuit board in the camera body to the controlled unit is ensured even when the lens barrel is moved back and forth.

In the camera described above, when the zoom lens barrel moves back and forth, there is a possibility that the FPC enters into a photographing optical path of a photographing optical system and hence a pathway of a photographing beam may be blocked by the FPC.

In view of such a circumstance, JP-A-10-170807, for example, discloses a structure of a zoom lens barrel having an FPC guiding member for preventing the FPC from entering into the photographing optical path by the back-and-forth movement of the lens frame.

### BRIEF SUMMARY OF THE INVENTION

The invention is an electronic device having a movable member which is capable of moving in the device, and an electric wire member which is arranged in the device so as to deform in association with the movement of the movable member, wherein a movable guiding member which is capable of moving independently from other members and guides the electric wire member in conjunction with the movement of the movable member is provided.

Therefore, deformation of the electric wire member in association with the movement of the movable member can be controlled by guiding of the movable guiding member.

A lens barrel is one of the examples of the electronic device to which the invention is applied.

For example, the movable guiding member can be provided on the movable member so as to be capable of relative movement. The movable guiding member can be provided on a fixed member provided within the electronic device so as to be capable of moving.

The electronic device having an electric unit therein and being adapted in such a manner that the electric wire member electrically connects the electric unit and an external electric unit of the electronic device can also be applicable. One end of the electric wire member can be connected to an electric unit provided on the movable member. One of the examples of such the electric wire member is a flexible printed electric board.

The electronic device described above can further have a fixed guiding member fixed in parallel with the movable guiding member. In this case, the electric wire member is guided between the movable guiding member and the fixed guiding member. In this arrangement, guiding of the electric wire member is facilitated.

The movable guiding member may be adapted so as to move in abutment with the movable member, and may be adapted to move in abutment with the electric wire member. In addition, it can also be adapted to have an additional movable member different from the movable member so that the additional movable member and the movable guiding member come into abutment to move the movable guiding member. In this arrangement, further accurate guiding is achieved by abutment.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a cross-sectional view of a lens barrel which is capable of detachably attached to a camera as an electronic device in a Tele state taken along an optical axis according to a first embodiment;

FIG. 2 is a cross-sectional view of the lens barrel in a Wide state taken along the optical axis according to the first embodiment;

FIG. 3 is a cross-sectional view of the lens barrel in a normal state taken along the optical axis according to the first embodiment;

FIG. 4 is an explanatory drawing of a general structure of a flexible printed circuit board and a movable guiding member according to the first embodiment;

FIG. 5 is a cross-sectional view of the lens barrel taken along the optical axis showing a state of being in the course of moving from the Tele state to the Wide state according to the first embodiment;

FIG. 6 is a cross-sectional view of the camera and the lens barrel thereof in the Tele state taken along the optical axis according to a second embodiment;

FIG. 7 is a cross-sectional view of the camera and the lens barrel in the state of moving from the Tele state to a retracted state taken along the optical axis according to the second embodiment;

FIG. 8 is a cross-sectional view of the lens barrel in the retracted state taken along the optical axis according to the second embodiment;

FIG. 9 is a cross-sectional view of the camera and the lens barrel thereof in the Tele state taken along the optical axis according to a third embodiment;

FIG. 10 is a cross-sectional view of the lens barrel in the retracted state taken along the optical axis according to the third embodiment; and

FIG. 11 is an explanatory drawing showing a general structure of the flexible printed circuit board and the movable guiding member according to the third embodiment.

### DETAILED DESCRIPTION OF THE PREFERRED EMBODIMENTS

Preferred embodiments of the invention are described below with reference to the accompanying drawings.

Referring now to the drawings, embodiments of the invention will be described.

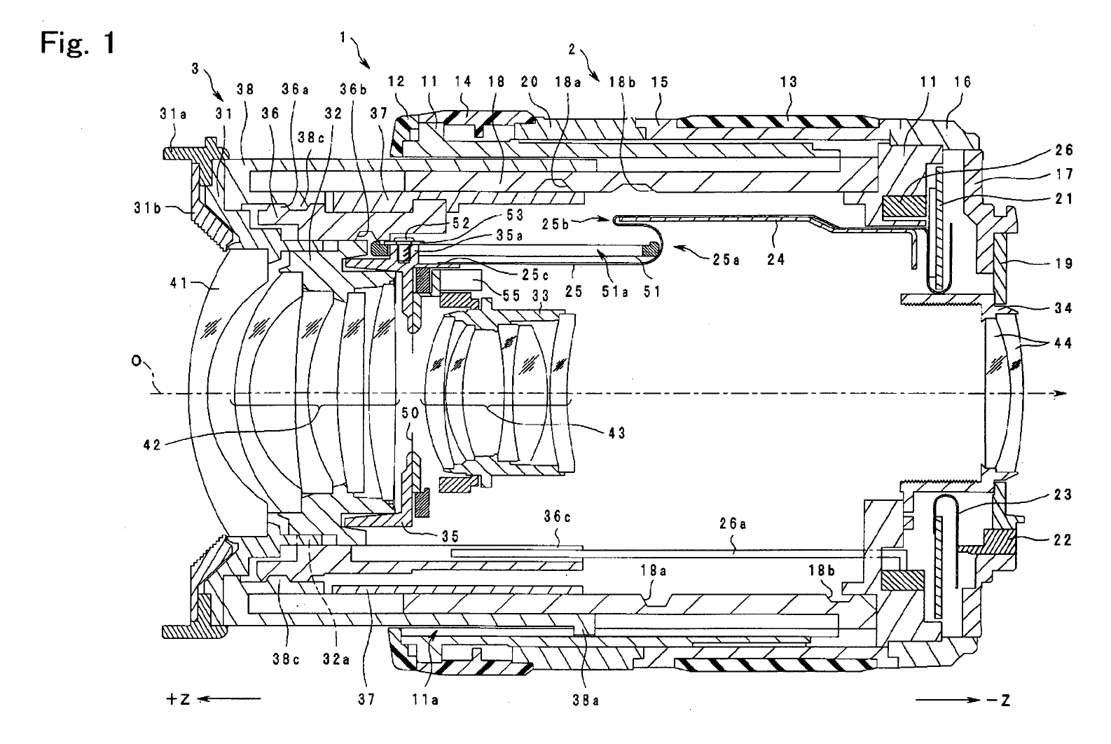

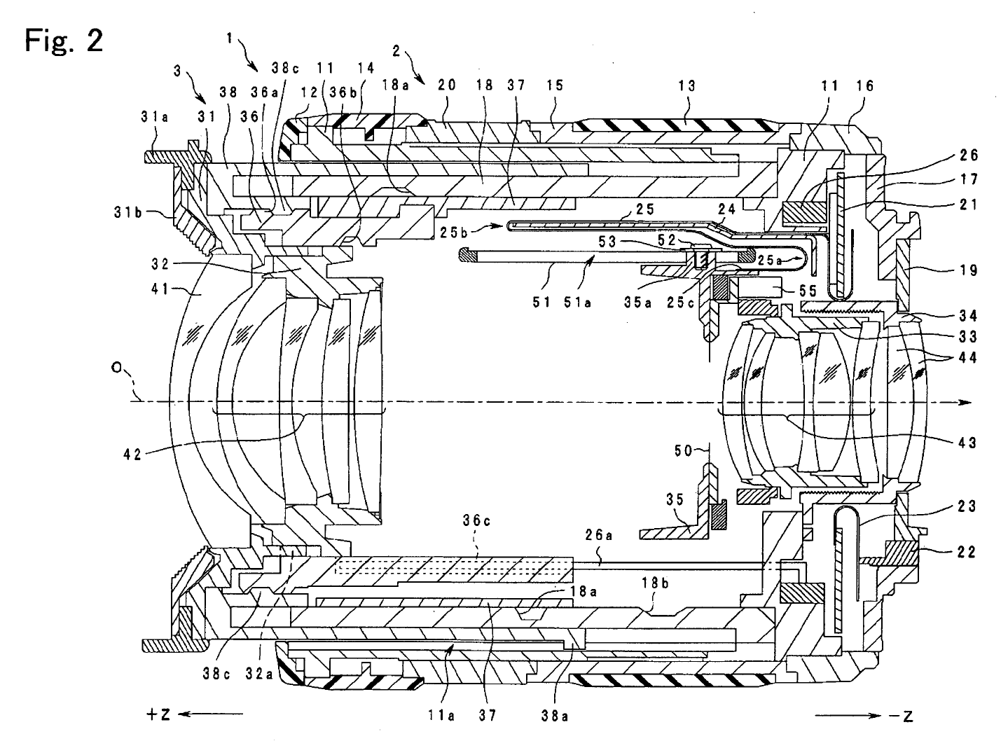

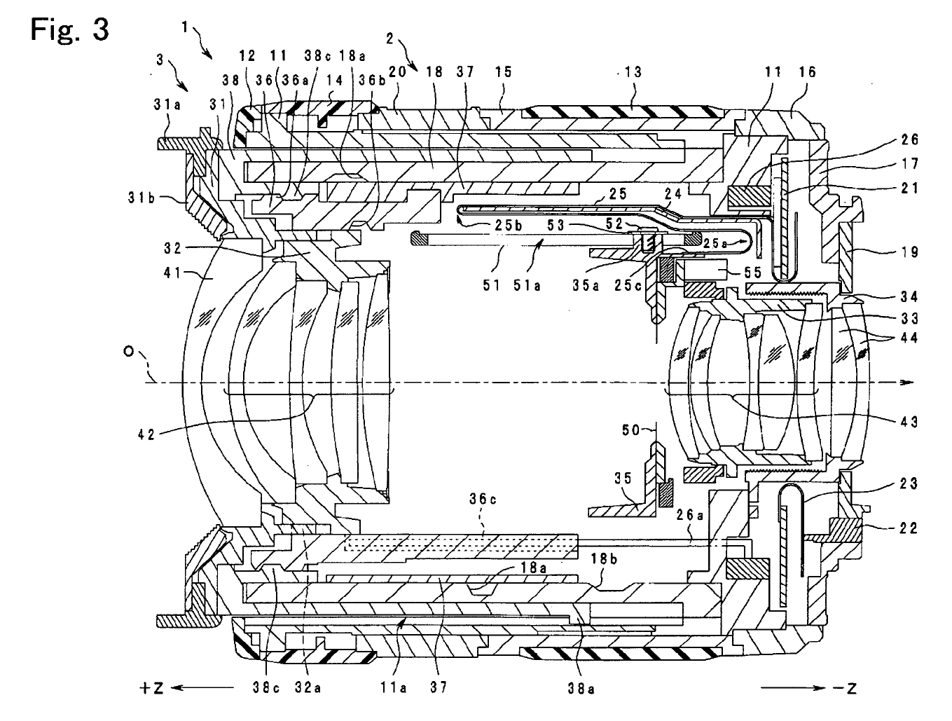

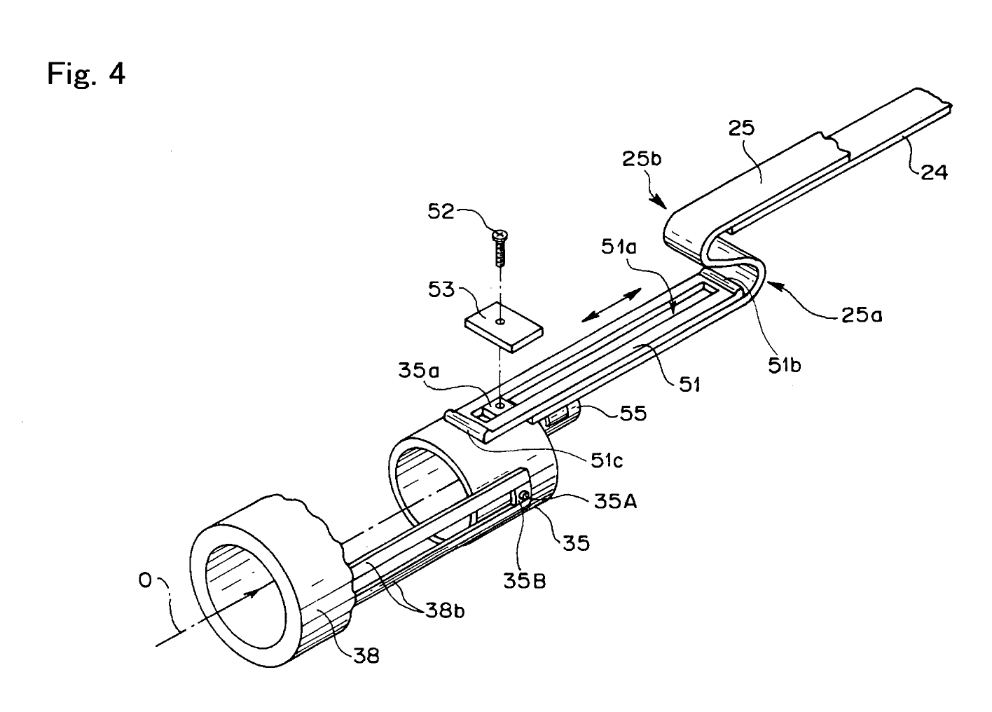

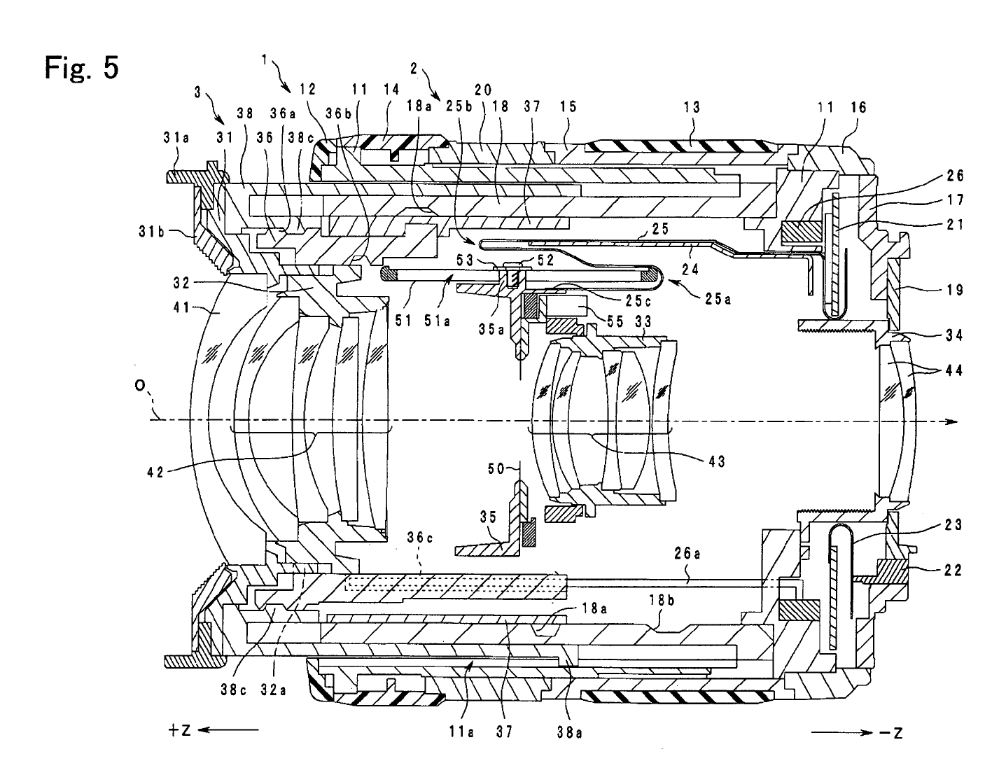

FIG. 1 to FIG. 5 are drawings relating to a first embodiment of the present invention. FIG. 1 is a cross-sectional view of a lens barrel in a Tele state taken along an optical axis according to the first embodiment; FIG. 2 is a cross-sectional view of the lens barrel in a Wide state taken along the optical axis according to the first embodiment; and FIG. 3 is a cross-sectional view of the lens barrel in a normal state taken along the optical axis according to the first embodiment. FIG. 4 is an explanatory drawing of a general structure of a flexible printed circuit board and a movable guiding member according to the first embodiment and FIG. 5 is a cross-sectional view of the lens barrel taken along the optical axis showing a state of being in the course of moving from the Tele state to the Wide state according to the first embodiment.

The lens barrel in the Tele state shown in FIG. 1 is a state in which the length in the direction of the optical axis is extended to the maximum. The lens barrel in the normal state shown in FIG. 3 is a state in which the length in the direction of the optical axis is reduced to the minimum.

In the first embodiment described below, the optical axis of an optical system (taking lens) of the lens barrel is represented by a reference numeral O, and a direction along the optical axis O is represented by a Z-direction. In the lens barrel shown in FIGS. 1 to 3 and FIG. 5, description will be made assuming that the direction toward a photographic subject is the front (+Z direction) and the direction of an imaging side is the rear (−Z direction).

A lens barrel 1 according to the first embodiment of the present invention, as shown in FIG. 1 to FIG. 3, is detachably mountable to a camera body (not shown) of a single lens reflex camera as an electronic device, and is a zoom lens barrel which can adjust a focal length. The lens barrel 1 includes a housing unit 2 forming mainly a housing and having a control board disposed at the rear portion of the interior thereof and an optical unit 3 being stored in the housing unit 2 and having the optical system built therein.

More specifically, the housing unit 2 of the lens barrel 1 includes a fixed frame 11, a front cover 12, a distance ring 14, a zoom ring 15, a first cam frame 18, a fixed intermediate frame 20, a rear cover 16 (of the fixed frame 11), a lens mount 17, a rear cover 19 (of the lens mount 17), and a lens drive ring (LD ring) 26.

The fixed frame 11 is a fixed member which encloses the optical unit 3, and includes a straight groove 11a formed thereon and a fixed guiding member 24, described later. The front cover 12 is mounted at a front of the fixed frame. The distance ring 14 is rotatably fitted to the fixed frame 11, and is used for focusing. The zoom ring 15 includes a rubber ring 13 fitted to an outer periphery thereof, is rotatable with respect to the fixed frame 11, and is used for zooming. The first cam frame 18 is securely fitted to the zoom ring 15 so as to form an integrated unit. The fixed intermediate frame 20 is disposed between the distance ring 14 and the zoom ring 15. The rear cover 16 is a rear end housing member to be disposed at the rear end for preventing movement of the zoom ring 15 or the like in the direction of the optical axis O. The lens mount 17 is secured to the back surface portion of the fixed frame 11. The rear cover 19 is securely inserted into an inner periphery of the lens mount 17. The lens drive ring 26 is rotatably fitted to the proximal side of the fixed frame 11, and is rotated by a focus motor (not shown) in the case of auto focusing. The lens drive ring 26 has a drive key 26a extending in parallel with the optical axis O, and is fitted in a straight groove 36c which is in parallel with the optical axis O provided on a second cam frame 36, described later. Therefore, when the lens drive ring 26 rotates, the second cam frame 36 rotates, and is capable of moving in the direction of the optical axis O.

The housing unit 2 is provided with a hard control board 21 between the fixed frame 11 and the lens mount 17 on the rear end side for controlling various drive systems. The hard control board 21 is electrically connected to a connecting terminal 22 disposed on the lens mount 17 via an electric wire 23. The connecting terminal 22 is a terminal electrically connected to a control circuit of the camera body in a state in which the lens mount 17 is mounted to a mount of the camera body (not shown) for receiving various signals.

On the other hand, the optical unit 3 of the lens barrel 1 includes a first-group lens retaining frame 31, a second-group lens retaining frame 32, a third-group lens retaining frame 33, a fixed lens frame 34, an aperture frame 35, a first movable frame 38, the second cam frame 36, and a second movable frame 37.

The first-group lens retaining frame 31 includes a filter ring 31a and a decoration ring 31b fixed on the front surface side and fixedly retains first-group lenses 41. The second-group lens retaining frame 32 fixedly retains second-group lenses 42. The third-group lens retaining frame 33 fixedly retains third-group lenses 43. The fixed lens frame 34 fixedly retains fourth-group lenses 44. The aperture frame 35 is secured on the front surface side of the third-group lens retaining frame 33, includes aperture blades 50, and is a movable frame. The first movable frame 38 is secured to the first-group lens retaining frame 31, and has a projection 38a to be guided by the straight groove 11a on the fixed frame 11. The second cam frame 36 is capable of rotating and moving back and forth in the direction of the optical axis O. The second movable frame 37 is fitted to the second cam frame 36 integrally in the direction of the optical axis O so as to be capable of relative rotation.

The aperture frame 35 which moves together with the third-group lens retaining frame 33 is provided with an aperture drive motor 55 as an electric unit and an aperture detection device (not shown). The aperture frame 35 is provided with a movable guiding member 51 which is a movable guiding member being capable of moving back and forth in the direction of the optical axis O relatively with and independently of the aperture frame 35.

The aperture drive motor 55 and the aperture detection device to be disposed in the aperture frame 35 are electrically connected to the hard control board 21 on the side of the housing unit 2 via a flexible printed circuit board (hereinafter referred to as FPC) 25 which is a band-shaped flexible electric signal line. The FPC 25 is partly adhered to the fixed guiding member 24 of the fixed frame 11.

Subsequently, a connecting state of the respective frames of the lens barrel 1 will be described in brief.

The first cam frame 18 is connected to the second movable frame 37 by engagement between a cam groove 18a provided on the inner periphery thereof and a cam follower (not shown) of the second movable frame 37. Likewise, a cam groove 18b provided on the inner periphery of the first cam frame 18 engages with a cam follower 35A (see FIG. 4) of the aperture frame 35 fixed to the third-group lens retaining frame 33, so that the first cam frame 18 is connected to the third-group lens retaining frame 33 via the aperture frame 35.

The second cam frame 36 which is integral with the second movable frame 37 is connected to the second-group lens retaining frame 32 by engagement between a cam groove 36b provided on the inner periphery and a cam follower (not shown) of the second-group lens retaining frame 32. A male helicoid 36a provided on the outer periphery of the second cam frame 36 engages with a female helicoid 38c provided on the inner periphery of the first movable frame 38, so that the second cam frame 36 is connected to the first movable frame 38.

In the lens barrel 1 of the first embodiment, the first-group lenses 41, the second-group lenses 42 and the third-group lenses 43 are moved back and forth along the direction of the optical axis O in association with the rotational drive of the zoom ring 15. In the lens barrel 1, a focus motor (not shown) rotates the LD ring 26 in association with rotation of the distance ring 14, and the second-group lenses 42 and the third-group lenses 43 provided therein are driven back and forth in the direction of the optical axis O.

Subsequently, referring now to FIG. 1 to FIG. 4, the aperture frame 35, the movable guiding member 51, the fixed guiding member 24, and the FPC 25 will be described.

FIG. 4 is a drawing for explaining the movable guiding member 51 in detail, and some members are shown in a simplified manner. For example, the second-group lens retaining frame 32 is not shown in the drawing.

As shown in FIG. 4, the movable guiding member 51 is a plate-shaped member having an elongated hole 51a along a longitudinal direction (the direction of the optical axis O), and having a shorter side (in the direction about the optical axis O) substantially the same length as the length of the shorter side (in the direction about the optical axis O) of the FPC 25. On the other hand, the aperture frame 35 is formed with a projection 35a on the outer peripheral surface thereof on the rear side in the direction of the optical axis O.

The projection 35a is slidably inserted into the elongated hole 51a of the movable guiding member 51. A holding plate 53 is attached to the projecting end of the projection 35a with a screw 52 so that the projection 35a can be slid in a state of being inserted into the elongated hole 51a without coming apart from the elongated hole 51a. Accordingly, the movable guiding member is supported so as to be movable back and forth in the direction of the optical axis O independently and freely from the aperture frame 35.

The movable guiding member 51 is located on the side of the optical axis O (inner diameter side) with respect to the fixed guiding member 24 described later. The movable guiding member 51 and the fixed guiding member 24 are arranged in parallel with the optical axis O at different positions in the direction of the diameter of the lens barrel, so as to be capable of overlapped with each other in the direction of the diameter of the lens barrel. The movable guiding member 51 and the fixed guiding member 24 are arranged in parallel with each other at a predetermined distance so that a gap for inserting the FPC 25 is defined therebetween in terms of the vertical direction, that is, between the upper surface of the movable guiding member 51 and the lower surface of the fixed guiding member 24.

The longitudinal length of the movable guiding member 51 is set so that at least a portion at the rear end thereof overlaps with the fixed guiding member 24 in the direction of the diameter of the lens barrel irrespective of whether the lens barrel 1 assumes the Tele state, the Wide state, or the normal state, as shown in FIG. 1 to FIG. 3. The movable guiding member 51 is capable of moving back and forth in the direction of the optical axis O in the range of the longitudinal length of the elongated hole 51a.

The fixed guiding member 24 is a plate shaped member being fixed integrally to the fixed frame 11 and having a shorter side substantially the same length of the shorter side of the FPC 25 (see FIG. 3). One end of the fixed guiding member 24 in the longitudinal direction is fixedly disposed inside the rear end side of the fixed frame 11. The length of the fixed guiding member 24 is set to a length which does not cause abutment with the respective lens frames which are retracted in the state in which the length of the lens barrel 1 is minimized in the direction of the optical axis O, that is, in the normal state (See FIG. 3).

The FPC 25 is attached and fixed to an upper surface of the fixed guiding member 24 in the drawing, that is, on the surface of the outer peripheral side with double-faced tape or the like partly at a midsection of the band-shaped portion. The FPC 25 is provided with curved portions 25a, 25b which are bent into a U-shape so as to cover the front end portion of the fixed guiding member 24 and the rear end portion of the movable guiding member 51 at positions nearby. The FPC 25 extends from the upper surface of the fixed guiding member 24 through the two U-shaped portions 25a, 25b along the back surface of the movable guiding member 51 to the side of the aperture frame 35.

The FPC 25 is connected at the band-shaped distal end portion thereof to the aperture drive motor 55 and the aperture detection device (not shown), and a distal portion 25c thereof is securely bonded to the outer peripheral surface of the rear portion of the aperture frame 35. The FPC 25 assumes a threefold state (a state folded into a so-called S-shape), and is guided and retained by the fixed guiding member 24 and the movable guiding member 51 so as not to enter into a beam.

When the lens barrel 1 shown in FIG. 1 is in the Tele state, the FPC 25 extends along the lower surface of the movable guiding member 51 at the portion from the above-described distal portion 25c to the curved portion 25a, and the length of the midsection from the curved portion 25a to the curved portion 25b becomes the minimum. Then, the midsection is inserted (exists) in the gap defined between the movable guiding member 51 and the fixed guiding member 24. At this time, the FPC 25 is deployed into the threefold state in which the length in the direction of the optical axis O becomes the maximum, and is guided and retained by the fixed guiding member 24 and the movable guiding member 51 so as not to enter into the beam.

When the lens barrel 1 shown in FIG. 2 and FIG. 3 is in the normal and in the Wide state, the length of the midsection from the curved portion 25a to the curved portion 25b of the FPC 25 becomes the maximum, and the midsection is inserted (exists) in the gap defined by the movable guiding member 51 and the fixed guiding member 24. At this time, the length of the FPC 25 in the direction of the optical axis O is the minimum in the threefold state, and is guided and retained by the fixed guiding member 24 and the movable guiding member 51 so as not to enter into the beam.

In order to accommodate a travel distance of the aperture frame 35, the length of the FPC 25 in the direction of the optical axis O is set so as to achieve a sufficient deployment. In other words, as shown in FIG. 1, the length of the FPC 25 is set considering that the FPC 25 electrically connects the aperture drive motor 55 of the aperture frame 35 and the hard control board 21 within the lens barrel 1 in the Tele state in which the length in the direction of the optical axis O becomes the maximum.

As shown in FIG. 4, the first movable frame 38 includes a rail portion 38b having a straight guide groove extending in the direction of the optical axis O in order to constrain the aperture frame 35 so as not to rotate in the direction of the optical axis O. In other words, the aperture frame 35 includes a projection 35B for mounting the cam follower 35A on the outer peripheral surface thereof, and the projection 35B is fitted into the straight guide groove of the rail portion 38b and guided to move straightly, rotation about the optical axis O is constrained with the third-group lens retaining frame 33.

The second-group lens retaining frame 32 is guided to move straightly and not to rotate about the optical axis O by a straight guiding portion 32a provided on the first-group lens retaining frame 31 and the second-group lens retaining frame 32.

Referring now to FIG. 1 to FIG. 3 and FIG. 5, the back-and-forth movement of the first-group lenses 41 to the third-group lenses 43 and the aperture frame 35 at the time of zooming of the lens barrel 1, and the operation of the FPC 25 and the movable guiding member 51 at the same timing configured as described above will be described.

Firstly, when the lens barrel 1 is zoomed from the Tele state in FIG. 1 to the Wide state in FIG. 2, the LD ring 26 is retained in an unrotatable state. When the zoom ring 15 is rotated in a predetermined direction for zooming, the first cam frame 18 is rotated in association with the zoom ring 15. In association with the rotation of the first cam frame 18, the second movable frame 37 and the second cam frame 36 are retracted in the −Z direction without rotation by the cam groove 18a of the first cam frame 18 via the cam follower (not shown) of the second movable frame 37. At this time, the first movable frame 38 is retracted in the −Z direction together with the first-group lens retaining frame 31 via the female helicoid 38c and the male helicoid 36a of the second cam frame 36. The second-group lens retaining frame 32 is retracted in the −Z direction by the cam groove 36b of the second cam frame 36 via a cam follower (not shown).

The first movable frame 38 is guided straightly in the direction of the optical axis O by the straight groove 11a of the fixed frame 11, and the second-group lens retaining frame 32 is adapted not to rotate by the straight guiding portion 32a and is moved in the direction of the optical axis together with the first-group lens retaining frame 31. The aperture frame 35 is driven toward the rear in the direction of the optical axis (−Z direction) by the cam groove 18b. The lens barrel 1 assumes the normal state shown in FIG. 3, that is, the state in which the length in the direction of the optical axis O is the minimum. When the lens barrel 1 according to the first embodiment is converted from the Wide state to the normal state, the third-group lens retaining frame 33 and the aperture frame 35 are kept in substantially immobile state.

When the zoom ring 15 is rotated in the predetermined direction for zooming, the second movable frame 37 and the second cam frame 36 are extended out in the +Z direction by the cam groove 18a of the first cam frame 18 via the cam follower of the second movable frame 37 in association with the rotation of the interlocked first cam frame 18. Then, the first movable frame 38 and the first-group lens retaining frame 31 are extended out in the +Z direction by the second cam frame 36 via the female helicoid 38c of the first movable frame 38 and the male helicoid 36a of the second cam frame 36. The second-group lens retaining frame 32 is extended out in the +Z direction by the cam groove 36b of the second cam frame 36 via its cam follower (not shown).

The third-group lens retaining frame 33 is extended out in the +Z direction by the cam groove 18b of the second cam frame 18 via the cam follower 35A (see FIG. 4) together with the aperture frame 35. The aperture frame 35 which moves integrally with the third-group lens retaining frame 33 is guided straightly in the direction of the optical axis O by engagement of a straight key groove (not shown) provided on the aperture frame 35 with a straight groove (not shown) on the second movable frame 37 extending along the direction of the optical axis O.

The lens barrel 1 zoomed as described above assumes a predetermined Tele state shown in FIG. 5 and then to the maximum Tele state shown in FIG. 1 (a state in which the length in the direction of the optical axis O is the maximum) depending on the position of the rotational limit of the zoom ring 15 in the predetermined direction. When the lens barrel 1 is zoomed from the Wide state to Tele state, the respective frame members and the respective lenses are moved in the direction opposite from the above-described movement by operating the zoom ring 15 in the opposite rotational direction from the direction described above.

As shown in FIG. 1 to FIG. 3, the amount of the back-and-forth movement of the third-group lenses 43 in the direction of the optical axis O from the Tele state, to the Wide state and the normal state is the largest, that is, the distance of movement of the third-group lens retaining frame 33 and the aperture frame 35 in the direction of the optical axis O is the maximum.

When the lens barrel 1 is focused manually, the distance ring 14 is rotated manually. Both in the manual focusing and the auto-focusing, the focus motor drives focusing and the lens driving ring (LD ring) 26 is rotated as determined in advance. When the manual focusing and the auto-focusing are performed, the second-group lens retaining frame 32 and the first-group lens retaining frame 31 in the lens barrel 1 are relatively moved back and forth in the direction of the optical axis O. In the focusing operation of the lens barrel 1, the respective lens retaining frames 32, 31 are moved back and forth as determined in advance in the direction of the optical axis O by the cam groove 36b and the helicoid screws 36a, 38c via the cam follower.

When the respective lens frames of the lens barrel 1 displaced from the Wide state or the normal state to the Tele state are extended out in the +Z direction, the FPC 25 which is threefold state is moved in the +Z direction in association with the movement of the aperture frame 35 as the distal portion 25c is pulled. In other words, as the lens barrel 1 is converted into the Tele state, the relative distance between the hard control board 21 at the rear end of the fixed frame 11 and the aperture frame 35 increases, and hence the curved portion 25a of the FPC 25 at the midsection thereof is moved toward the front in the direction of the optical axis O thereby increasing the length from the distal portion 25c to the curved portion 25a of the FPC 25.

In this case, the FPC 25 is released from the gap defined by the fixed guiding member 24 and the movable guiding member 51 from the side of the curved portion 25a, and the midsection which is reduced in length (in this case, the portion from the curved portion 25a to the curved portion 25b) is guided and retained by the upper surface of the movable guiding member 51. The portion of the FPC 25 from the distal portion 25c to the curved portion 25a generates a tensile strength in the +Z direction by a force generated by abutment of the curved portion 25a with respect to the rear end portion of the movable guiding member 51, and hence the FPC 25 is retained substantially in a straight state along the lower surface of the movable guiding member 51 without being sagged.

The movable guiding member 51 is initially moved in the +Z direction along the movement of the FPC 25 while guiding and holding the curved portion 25a of the FPC 25 by the rear end portion thereof. Then, the movable guiding member 51 is moved in the +Z direction while keeping sliding contact between the midsection of the FPC 25 and the rear end portion thereof, and then is moved so that the rear end portion thereof moves apart from the curved portion 25a.

The movable guiding member 51 can freely move in +Z direction independently of the aperture frame 35 within a range of the length of the elongated hole 51a. Therefore, when the aperture frame 35 is moved in the +Z direction thereafter, the movable guiding member 51 comes into abutment with the second-group lens retaining frame 32 at a front end portion 51c thereof. The FPC 25 is supported at the curved portion 25a by a rear end portion 51b of the movable guiding member 51, and the portion from the distal portion 25c to the curved portion 25a is retained substantially in a straight state along the lower surface of the movable guiding member 51 without being sagged.

Then, the movable guiding member 51 is moved in the +Z direction by abutment between the projection 35a of the aperture frame 35 and the distal end of the elongated hole 51a. In this state as well, the portion of the FPC 25 from the distal portion 25c to the curved portion 25a is retained substantially straight state along the lower surface of the movable guiding member 51 without being sagged.

Consequently, when the respective frames of the lens barrel 1 displaced from the Wide state or the normal state to the Tele state are extended out in the +Z direction, the FPC 25 is cleared of the sag by the movable guiding member 51 and deployed while being retained. Accordingly, the entry of the FPC 25 into the photographing optical path is prevented.

On the other hand, when the lens barrel 1 is displaced from the Tele state to the Wide state or the normal state, the deployed FPC 25 is pushed at the distal portion secured to the aperture frame 35 in the −Z direction in association with the movement of the aperture frame 35 in the −Z direction. In other words, as the lens barrel 1 is converted to the Wide state, the relative distance between the hard control board 21 at the rear end side of the fixed frame 11 and the aperture frame 35 is reduced. Therefore, the curved portion 25a of the FPC 25 is moved toward the distal side thereof, and the length from the distal portion 25c to the curved portion 25a is gradually reduced.

At this time, the curved portion 25b of the FPC 25 covers the distal portion of the fixed guiding member 24, and the curved portion 25a comes into sliding contact with the rear end portion of the movable guiding member 51 as if it is pulled in the −Z direction along with the movement of the movable guiding member 51 in the −Z direction. Therefore, a predetermined tensile force is applied to the midsection of the FPC 25 located between the fixed guiding member 24 and the movable guiding member 51.

Consequently, the FPC 25 from the distal portion 25c to the curved portion 25a is gradually fed between the fixed guiding member 24 and the movable guiding member 51 as if it is pulled from the side of the curved portion 25a. Therefore, the FPC 25 from the distal portion 25c to the curved portion 25a assumes substantially a straight state along the lower surface of the movable guiding member 51 and retained without being sagged by the predetermined tensile force applied thereto.

The movable guiding member 51 is moved in the −Z direction in association with the movement of the FPC 25 and the aperture frame 35 while guiding and holding the curved portion 25a of the FPC 25 with the rear end portion thereof. Even when the movable guiding member 51 is moved in the +Z direction relatively with and independently of the aperture frame 35, the FPC 25 from the distal portion 25c to the curved portion 25a assumes substantially straight state along the lower surface of the movable guiding member 51, and is retained without being sagged.

The movable guiding member 51 may be moved in the −Z direction by abutment of the projection 35a of the aperture frame 35 with the rear end portion of the elongated hole 51a. In this state as well, the FPC 25 from the distal portion 25c to the curved portion 25a assumes substantially straight state along the lower surface of the movable guiding member 51 and is retained without being sagged.

Consequently, when the respective lens frames of the lens barrel 1 displaced from the Tele state to the Wide state or the normal state are extended out in the +Z direction, the FPC 25 is cleared of the sag and folded in three while being retained by the movable guiding member 51, and is prevented from entering into a photographing optical path.

As described above, in the lens barrel 1 according to the first embodiment, the FPC 25 is prevented from entering into the photographing optical path by the movable guiding member 51 in all the states including the extending and retracting process from the Tele state to the Wide state and the normal state.

The movable guiding member 51 can reduce the length for guiding and retaining the FPC 25 in the direction of the optical axis O corresponding to the travel distance of the aperture frame 35 in the direction of the optical axis O by being adapted to be movable relatively with respect to the aperture frame 35. As a consequence, the length of the lens barrel 1 in the direction of the optical axis O can be reduced.

More specifically, the travel distance of the FPC 25 secured at the distal portion thereof to the aperture frame 35 whose travel distance in the direction of the optical axis O is the longest among other movable members increases in association with the movement of the aperture frame 35. Therefore, it is necessary to secure a sufficient length of the movable guiding member 51 in the direction of the optical axis O in order to prevent entry of the FPC 25 into the photographing optical path. However, even though the length of the movable guiding member 51 in the direction of the optical axis O is set to be short, the FPC 25 can be guided and retained over the range of the travel distance of the aperture frame 35 by moving relatively with and independently of the aperture frame 35.

As a consequence, the length of the movable guiding member 51 in the direction of the optical axis O can be reduced, and the lens barrel 1 according to the first embodiment can be reduced in length in the direction of the optical axis O in the normal state (the state in which the length in the direction of the optical axis O is the minimum) while securing a space for various structures to be disposed in the interior thereof. In other words, according to the structure of the lens barrel 1 of the first embodiment described above, downsizing of the lens barrel 1 in the direction of the optical axis O is achieved. Owing to such a simple structure, unnecessary parts are not used, and hence even the outer diameter of the lens barrel need not to be increased, whereby downsizing of the lens barrel 1 can be realized.

Referring to the drawings, a second embodiment will be described.

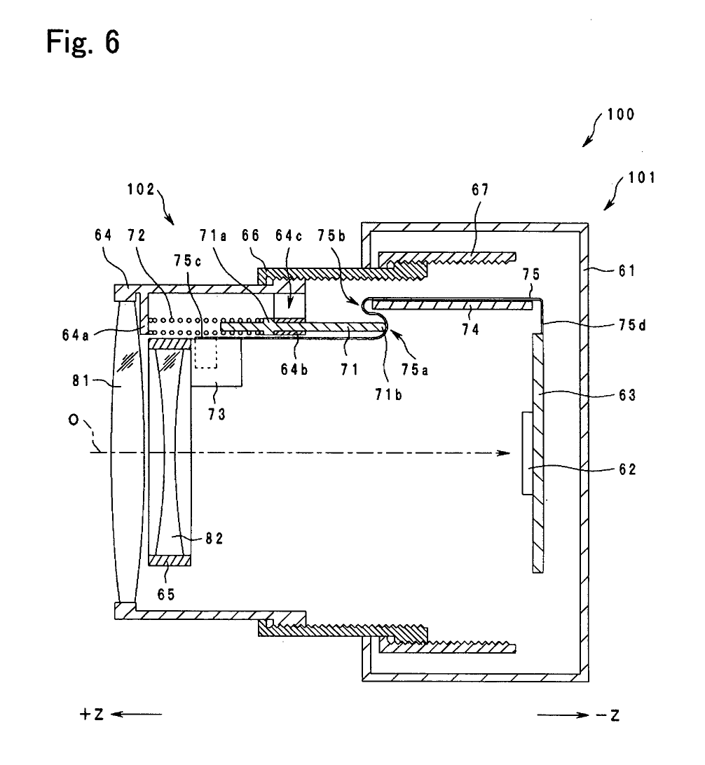

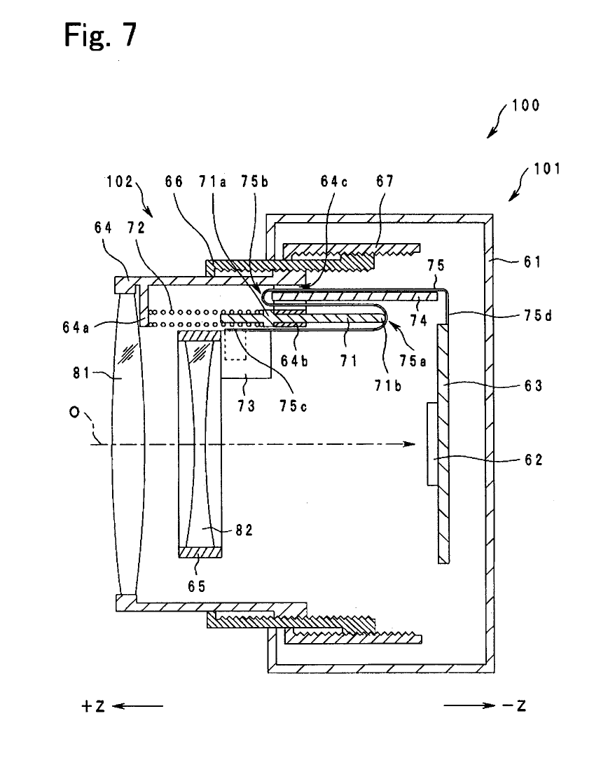

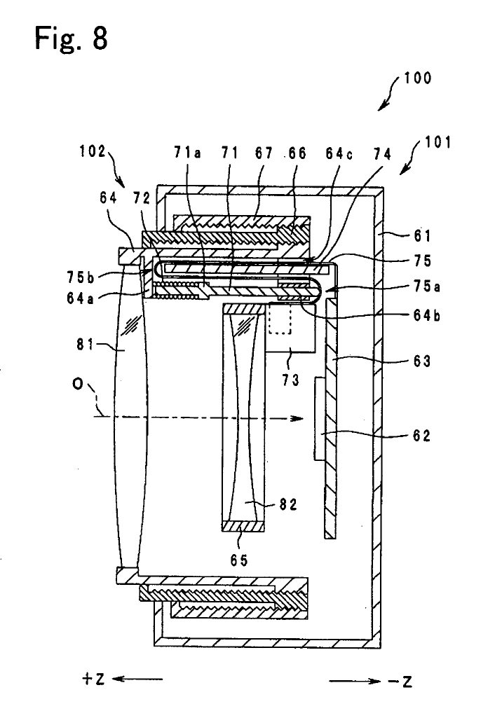

FIG. 6 to FIG. 8 are drawings relating to the second embodiment of the invention. FIG. 6 is a cross-sectional view of the camera and the lens barrel thereof in the Tele state taken along the optical axis; FIG. 7 is a cross-sectional view of the camera and the lens barrel in the state of moving from the Tele state to a retracted state taken along the optical axis; and FIG. 8 is a cross-sectional view of the lens barrel in the retracted state taken along the optical axis. In the description of the second embodiment as well, in the camera and the lens barrel shown in FIGS. 6 to 8, the optical axis of the optical system (taking lens) of the lens barrel is represented by the reference numeral O, and the direction along the optical axis O is represented by the Z-direction. Likewise, the description will be made assuming that the direction toward a photographic subject is the front (+Z direction) and the direction of an imaging side is the rear (−Z direction).

A camera 100 as an electronic device shown in FIG. 6 to FIG. 8 is a digital camera, and mainly includes a camera body 101, a lens barrel 102 which can be retracted into the camera body 101.

The camera body 101 includes a camera enclosure 61, and a hard control board 63 provided with a solid-state image-pickup element 62 such as a. CCD or a CMOS and stored in the camera enclosure 61. The camera enclosure 61 includes a drive motor, not shown, for driving the respective lens frames of the lens barrel 102 as determined in advance for zooming and focusing provided therein.

The lens barrel 102 includes a first movable frame 64, a second movable frame 65, a third movable frame 66, and a fixed frame 67. The first movable frame 64 also serves as a first-group lens retaining frame for retaining first-group lenses 81. The second movable frame 65 is a second-group lens retaining frame for retaining second-group lenses 82. The third movable frame 66 includes a male helicoid screw and a female helicoid screw on the outer periphery and the inner periphery thereof, and also includes a cam (not shown). The fixed frame 67 includes a female helicoid screw on the inner periphery, and is fixed to the camera enclosure 61.

The first movable frame 64 is provided with a stopper 64a so as to project from an inner wall rearwardly of the first-group lenses 81, and the rear surface of the stopper 64a opposes the front surface of a guide supporting portion 64b projecting inwardly at the rear end portion of the first movable frame 64. The first movable frame 64 is guided straightly by a straightly-movable guiding member or the like, not shown, provided on the fixed frame 67 so as not to rotate about the optical axis O.

The guide supporting portion 64b supports a plate-shaped movable guiding member 71 by insertion so as to be capable of moving back and forth in the direction of the optical axis O. The guide supporting portion 64b has a through portion 64c in which a fixed guiding member 74 and a flexible printed circuit board 75, described later, can be inserted even when the lens barrel 102 is retracted into the camera enclosure 61.

The second movable frame 65 can be moved back and forth in the direction of the optical axis O, and is provided with aperture blades (not shown), and is provided with an aperture driving motor 73 and an aperture detection device (not shown) as electric units for driving the aperture blades. The second movable frame 65 is guided straightly by the straightly-movable guiding member, not shown, provided in the fixed frame 67 so as not to rotate about the optical axis O as in the case of the first movable frame 64.

The third movable frame 66 can be moved back and forth in the direction of the optical axis O, and is rotated as determined in advance relative to the fixed frame 67 by a drive motor (not shown) of the camera body 101. When the movable frame 66 is rotated, the first movable frame 64 moves in the direction of the optical axis O by the helicoid screw, and the second movable frame 65 is moved back and forth in the +Z direction by a cam groove and a cam follower, not shown. The third movable frame 66 is moved back and forth in the ±Z direction with respect to the fixed frame 67 by the helicoid screw in association with the rotation of itself. Therefore, the respective lens frames of the lens barrel 102 are connected by the cam groove and the cam follower, whereby zooming or focusing is achieved by the rotation of the third movable frame 66.

The movable guiding member 71 supported by the guide supporting portion 64b of the first movable frame 64 includes, in the front side of the guide supporting portion 64b, an outward flange 71a at a midsection thereof, and a spring member 72 is interposed between the outward flange 71a and the stopper 64a. The movable guiding member 71 is urged rearward (the −Z direction) by the spring member 72.

The flexible printed circuit board (FPC) 75 is connected at one end (rear end) 75d to the hard control board 63, and at the other end (distal portion) 75c to the aperture drive motor 73 of the second movable frame 65. The flexible printed circuit board 75 has flexibility and is an electric signal line having a band-shape. The longitudinal length of the movable guiding member 71 is set so that at least a portion at the rear end thereof overlaps with the fixed guiding member 74 longitudinally of the lens barrel 102 in all the state from the Tele state to the retracted state, as shown in FIG. 6 to FIG. 8. The movable guiding member 71 is capable of moving back and forth in the direction of the optical axis O relatively with the first movable frame 64 in the range of the length from the outward flange 71a to the rear end.

Disposed in the fixed frame 67 is, as in the case of the first embodiment, the fixed guiding member 74 on which the midsection of the FPC 75 fixedly bonded on the upper surface thereof. The fixed guiding member 74 is provided at the rear end side of the fixed frame 67, and the longitudinal length which does not cause abutment with the retracted respective lens frames in a state in which the length of the lens barrel 102 in the direction of the optical axis O become the minimum, that is, in the retracted state (see FIG. 8).

The movable guiding member 71 of the second embodiment is provided in the lens barrel 102 on the side of the optical axis O with respect to the fixed guiding member 74, described later, so as to extend in parallel with the optical axis O and with the fixed guiding member 71 as in the case of the movable guiding member 51 in the first embodiment. The movable guiding member 71 and the fixed guiding member 74 are arranged in parallel with each other at a predetermined distance so that a gap for inserting the FPC 75 is defined therebetween in terms of the vertical direction, that is, between the upper surface of the movable guiding member 71 and the lower surface of the fixed guiding member 74.

The FPC 75 is provided with curved portions 75a, 75b which are bent into a U-shape so as to cover the front end portion of the fixed guiding member 74 and the rear end portion of the movable guiding member 71, and the distal portion extends toward the second movable frame 65 along the lower surface of the movable guiding member 71. The FPC 75 assumes a threefold state (a state folded into a so-called S-shape) in a state in which the lens barrel 102 is in the Wide state shown in FIG. 7, and is guided and retained by the fixed guiding member 74 and the movable guiding member 71 so as not to enter into a beam. The length of the FPC 75 in the direction of the optical axis O is set so as to achieve a sufficient deployment in order to accommodate the travel distance of the second movable frame 65.

The operation of the FPC 75 and the movable guiding member 71 for guiding and retaining the FPC 75 when the respective lens frames in the lens barrel 102 according to the second embodiment configured as described above are retracted from the Tele state in FIG. 6 to the retracted state in FIG. 8 will be described below.

Firstly, when the first movable frame 64, the second movable frame 65 and the third movable frame 66 are moved in the −Z direction, the distal portion 75c of the FPC 75 connected to the motor 73 is moved in the −Z direction in association with the movement of the second movable frame 65. At this time, the movable guiding member 71, being applied with the urging force of the spring member 72 in the −Z direction, moves in the −Z direction in a state in which the outward flange 71a comes into abutment with the guide supporting portion 64b. In this state, a rear end portion 71b of the movable guiding member 71 pushes and moves the curved portion 75a of the FPC 75 in the −Z direction.

At this time, the curved portion 75a of the FPC 75 is moved toward the distal end side of the FPC 75 in sliding contact with the rear end of the movable guiding member 71. In other words, as shown in FIG. 7, the length of the FPC 75 in the direction of the optical axis o from the distal portion 75c located on the lower surface of the movable guiding member 71 to the curved portion 75a is gradually reduced, and the midsection is fed between the fixed guiding member 74 and the movable guiding member 71.

More specifically, the relative distance between the hard control board 63 on the side of the rear end and the second movable frame 65 is reduced as the lens barrel 102 is converted from the Tele state to the Wide state. Therefore, the length from the curved portion 75a to the curved portion 75b of the FPC 75 is gradually increased, and the distal portion thereof is moved in the −Z direction, whereby a threefold shape (so called S-shape) is achieved.

A predetermined tensile force is applied to the portion of the FPC 75 from the curved portion 75a to the curved portion 75b located between the fixed guiding member 74 and the movable guiding member 71. Furthermore, a predetermined tensile force is applied also to the portion of the FPC 75 between the distal portion 75c to the curved portion 75a. Consequently, the portion of the FPC 75 from the curved portion 75a to the curved portion 75b assumes substantially straight state along the upper surface of the movable guiding member 71, and the portion of the FPC 75 from the distal portion 75c to the curved portion 75a assumes substantially the straight state along the lower surface of the movable guiding member 71, so that the FPC 75 is retained without being sagged.

At this time, the first movable frame 64 moves in the −Z direction so that the fixed guiding member 74 is inserted into the through portion 64c of the guide supporting portion 64b of the first movable frame 64 from the side of the distal end of the fixed guiding member 74 together with the curved portion 75b of the FPC 75.

In a state in which the lens barrel 102 is retracted into the camera enclosure 61 shown in FIG. 8, the relative distance between the hard control board 63 and the second movable frame 65 becomes the minimum, and the movable guiding member 71 is moved in the +Z direction to the maximum with respect to the second movable frame 65 by a force of abutment of the curved portion 75a of the FPC 75. Accordingly, the spring member 72 is brought into a state of being contracted to the maximum.

In this state, the FPC 75 assumes a folded state into the S-shape through gaps defined by the first movable frame 64, the fixed guiding member 74, the movable guiding member 71, and the second movable frame 65 respectively.

As a consequence, when the respective lens frames of the lens barrel 102 which is operated from the Tele state to the Wide state or the retracted state are retracted in the −Z direction, the FPC 75 is bent and folded while being guided and retained by the movable guiding member 71 and the fixed guiding member 74 without being sagged into the photographing optical path, and hence is prevented from entering into the photographing optical path.

On the other hand, when the respective lens frames of the lens barrel 102 operated from the retracted state to the Tele state is extended out in the +Z direction, the movable guiding member 71 is moved in the direction opposite from that described above while applying the predetermined tensile force to the FPC 75 by the urging force of the spring member 72 and the abutment force of the curved portion 75a of the FPC 75. Therefore, the threefold FPC 75 is deployed without being sagged while being guided and held by the movable guiding member 71 and the fixed guiding member 74, and hence the entry into the photographing optical path is prevented.

As described above, according to the lens barrel 102 in the second embodiment, since the urging force of the spring member 72 in the −Z direction is applied to the movable guiding member 71 in all the states including the extending and retracting process from the Tele state to the retracted state, the FPC 75 is cleared of the sag and the entry into the photographing optical path is prevented.

In the first embodiment, the movable guiding member is adapted to be movable relatively with respect to the aperture frame (which corresponds to the second movable frame 65 in the second embodiment). In the second embodiment, the movable guiding member 71 is adapted to be relatively movable with respect to the first movable frame 64, so that the length for guiding and retaining the FPC 75 in the direction of the optical axis O, which corresponds to the travel distance of the first movable frame 64 in the direction of the optical axis O can be reduced.

Consequently, the lens barrel 102 according to the second embodiment can achieve the advantage of the first embodiment and the length in the direction of the optical axis O in the retracted state (the state in which the length in the direction of the optical axis O becomes the minimum) can be reduced. Therefore, the camera 100 having the lens barrel 102 which can be retracted may be downsized.

Referring now to the drawings, a third embodiment will be described.

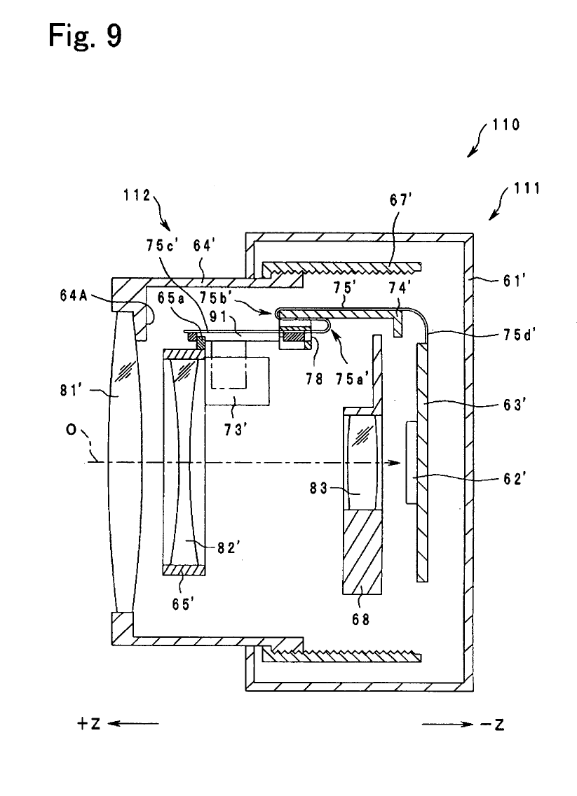

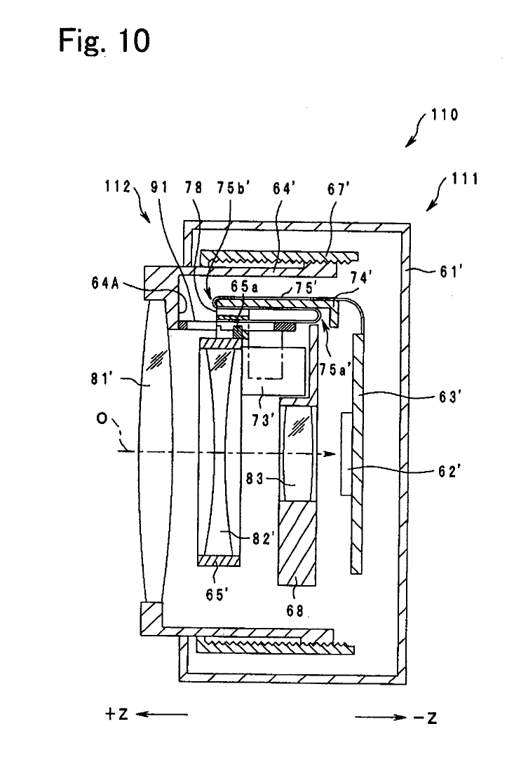

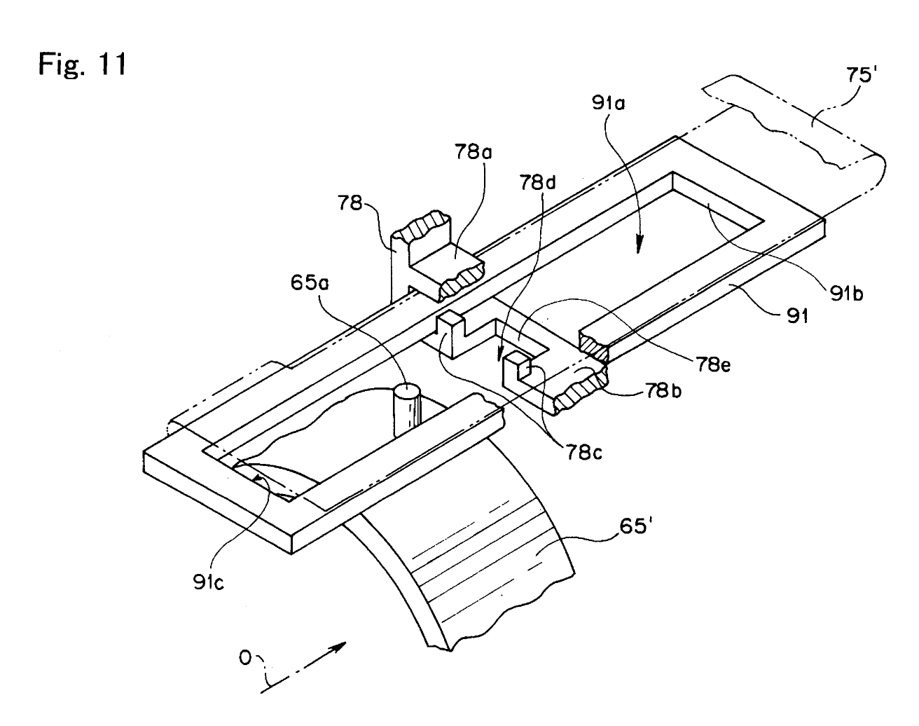

FIG. 9 to FIG. 11 are drawings relating to the third embodiment of the invention. FIG. 9 is a cross-sectional view of the camera and the lens barrel thereof in the Tele state taken along the optical axis; FIG. 10 is a cross-sectional view of the lens barrel in the retracted state taken along the optical axis; and FIG. 11 is an explanatory drawing showing a general structure of the flexible printed circuit board and the movable guiding member. In the description of the third embodiment as well, the optical axis of the optical system (taking lens) of the lens barrel is represented by the reference numeral O, and the direction along the optical axis O is represented by the Z-direction. Likewise, the description will be made assuming that the side of the lens barrel in the z-direction where a photographic subject is located is the front (+Z direction) and the side where an image is formed is the rear (−Z direction). A camera 110 shown in FIG. 9 and FIG. 10 is a digital camera, and includes a camera body 111, a lens barrel 112 which can be retracted into the camera body 111.

The camera body 111 includes a camera enclosure 61′, and a hard control board 63′ provided a solid-state image-pickup element 62′ such as the CCD or the CMOS and built in the camera enclosure 61′.

The lens barrel 112 includes a first movable frame 64′, a second movable frame 65′, a fixed frame 67′, and a third-group lens retaining frame 68. The first movable frame 64′ also serves as a first-group lens retaining frame for retaining first-group lenses 81′, and includes a male helicoid screw on the outer periphery at the rear end in the direction of the optical axis O. The second movable frame 65′ is a second-group lens retaining frame for retaining second-group lenses 82′. The fixed frame 67′ is fixed to the camera enclosure 61′, and includes a female helicoid screw on the inner peripheral surface thereof. The third-group lens retaining frame 68 retains third-group lenses 83.

The first movable frame 64′ is provided with an abutment portion 64A projecting from the inner wall on the back side of the first-group lenses 81′. The first movable frame 64′ is moved relatively with respect to the fixed frame 67′ back and forth in the direction of the optical axis O by screwing between the male helicoid screw and the female helicoid screw. The first movable frame 64′ is rotated as determined in advance by a drive motor (not shown) which is disposed in the camera enclosure 61′ for the back-and-forth movement in the direction of the optical axis O.

The second movable frame 65′ includes a pin member 65a projecting upward, a cam follower (not shown), and aperture blades (not shown), and an aperture drive motor 73′ as electric units for driving the aperture blades and an aperture detection device (not shown) are disposed. The second movable frame 65′ is capable of moving back and forth in the direction of the optical axis O by a cam groove (not shown) of the first movable frame 64′ via the cam follower, and is straightly guided by a straightly movable guiding member (not shown) provided in the fixed frame 67′ so as not to rotate about the optical axis O.

The fixed frame 67′ is provided with a fixed guiding member 74′. Provided on the lower surface of the distal portion of the fixed guiding member 74′ toward the direction of the photographing optical path (in the direction of the inner diameter of the lens barrel) so as to project therefrom is a guide supporting portion 78 which supports a movable guiding member 91 for guiding a flexible printed circuit board (FPC) 75′ so as to be capable of back and forth movement in the direction of the optical axis O. A third-group lens retaining frame 68′ is fixed in the fixed frame 67′ so as to be located near the solid-state image-pickup element 62′.

Subsequently, the movable guiding member 91, the guide supporting portion 78, the second movable frame 65′, and the FPC 75′ will be described in detail.

The movable guiding member 91 supported by the guide supporting portion 78 includes an elongated hole 91a along the longitudinal direction as shown in FIG. 11, and is a plate shaped member whose length of the short side (direction of the circumference of the lens-barrel) having substantially the same length as the short side of the FPC 75′. The movable guiding member 91 is inserted into a space defined by the inner side surface of the guide supporting portion 78, an upper plate portion 78a, and a lower plate portion 78b, and is supported so as to move back and forth in the direction of the optical axis O.

The lower plate portion 78b of the guide supporting portion 78 is provided at the distal end side with two stopper portions 78c projecting upward along the both inner walls of the elongated hole 91a, and is formed with a recess 78d cut out at the center portion from the front side to the rear side. The two stopper portions 78c are stoppers for constraining the movement of the movable guiding member 91 in the direction of the optical axis O (+Z direction) by abutment with an inner wall 91b at the rear end of the movable guiding member 91.

A distal portion 75c′ of the band-shaped flexible printed circuit board 75′ extending along the optical axis O is secured to the second movable frame 65′, and the distal portion 75c′ of the FPC 75′ is connected to the aperture drive motor 73 (see FIG. 9 and FIG. 10) and the aperture detection device (not shown).

The pin member 65a projecting from the upper portion of the second movable frame 65′ is inserted into the elongated hole 91a of the movable guiding member 91 on the front side of the guide supporting portion 78. By the abutment of the pin member 65a with an inner wall 91c at the distal end of the elongated hole 91a of the movable guiding member 91, the movable guiding member 91 is guided and moved to be extended out toward the front in the direction of the optical axis O in association with the movement of the second movable frame 65′ toward the front (+Z direction) in the direction of the optical axis O.

The movement of the second movable frame 65′ backward in the direction of the optical axis O (−Z direction) is restrained by the abutment of the pin member 65a with respect to the rear end wall 78e of the recess 78d of the guide supporting portion 78.

The FPC 75′ whose distal portion 75c′ is secured to the second movable frame 65′ is connected at the rear end 75d′ to a hard control board 63a, and is inserted between the movable guiding member 91 and the upper plate portion 78a of the guide supporting portion 78, and is guided and retained along the upper surface of the movable guiding member 91. The FPC 75′ is provided with curved portions 75b′, 75a′ which are bent into a U-shape near the front end portion of the fixed guiding member 74′ and the rear portion of the movable guiding member 91. The distal end portion of the distal portion 75c′ of the FPC 75′ extends downwardly of the movable guiding member 91 and secured to the side of the second movable frame 65′. The FPC 75′ assumes a threefold state (a state folded into a so-called S-shape) in a state in which the lens barrel 102 is retracted as shown in FIG. 10, and is guided and retained by the fixed guiding member 74′ and the movable guiding member 91 so as not to enter into a beam. In order to accommodate the travel distance of the movable frame 65′, the length of the FPC 75′ in the direction of the optical axis O is set to achieve a sufficient deployment. The distal portion 75c′ of the FPC 75′ is not secured to the movable guiding member 91.

The operation of the FPC 75′ and the movable guiding member 91 for guiding and retaining the FPC 75′ of the lens barrel 112 according to the third embodiment configured as described above when the respective lens frames are retracted from the Tele state in FIG. 9 into the retracted state shown in FIG. 10 will be described.

When the lens barrel 112 is firstly converted from the Tele state to the retracted state, the first movable frame 64′ moves in the −Z direction while rotating as determined in advance. In association with the rotation of the first movable frame 64′, the second movable frame 65′ moves in the −Z direction by the cam groove (not shown) of the first movable frame 64′ via the cam follower (not shown) thereof.

Then, the abutment portion 64A of the first movable frame 64′ comes into abutment with the distal portion of the movable guiding member 91, and moves in the −Z direction while pressing the movable guiding member 91 in the −Z direction. In this state, the movable guiding member 91 which comes into abutment with the abutment portion 64A of the first movable frame 64′ retains the FPC 75′ on the upper surface thereof.

The distal portion of the FPC 75′ is pushed in the −Z direction in association with the movement of the second movable frame 65′, and the portion retained on the upper surface of the movable guiding member 91 (the portion from the distal end portion to the curved portion 75a′) moves in the −Z direction while slightly sliding along the upper surface of the movable guiding member 91. In other words, the length of the FPC 75′ from the distal portion located on the upper surface of the movable guiding member 91 to the curved portion 75a′ in the direction of the optical axis O is gradually reduced.

As the lens barrel 112 is retracted, the relative distance between the hard control board 63′ on the rear end side and the second movable frame 65′ becomes shorter. Therefore, the length of the FPC 75′ from the curved portion 75a′ to the curved portion 75b′ is gradually increased as it is fed between the fixed guiding member 74′ and the movable guiding member 91 from the side of the curved portion 75a′. Then, the FPC 75′ is retained by the lower surface of the fixed guiding member 74′ and the upper surface of the movable guiding member 91 so as not to enter into the photographing optical path, and is folded in three.

The second movable frame 65′ is prevented from moving in the −Z direction by abutment of the pin member 65a with the rear end wall 78e of the recess 78d of the guide supporting portion 78.

On the other hand, when the lens barrel 1 is converted from the retracted state to the Tele state, the first movable frame 64′ moves in the +Z direction while rotating in the opposite direction from the direction described above. In association with the rotation of the first movable frame 64′, the second movable frame 65′ moves in the +Z direction by the cam groove (not shown) of the first movable frame 64′ via the cam follower (not shown).

The pin member 65a of the second movable frame 65′ comes into abutment with the distal inner wall 91c of the elongated hole 91a, and in association with the movement of the second movable frame 65′ in the +Z direction, the movable guiding member 91 is fed in the +Z direction while retaining the FPC 75′ on the upper surface thereof.

In association of the movement of the second movable frame 65′, the distal portion of the FPC 75′ is pulled in the +Z direction, and the portion retained on the upper surface of the movable guiding member 91 (the portion from the distal end to the curved portion 75a′) moves in the +Z direction while slightly sliding on the upper surface of the movable guiding member 91. The length of the FPC 751 from the distal portion located on the upper surface of the movable guiding member 71′ to the curved portion 75a′ in the direction of the optical axis O is gradually increased.

As the lens barrel 112 is converted to the Tele state, the relative distance between the hard control board 63′ on the rear side and the second movable frame 65′ is increased. Therefore, the midsection of the FPC 751 between the fixed guiding member 74′ and the movable guiding member 91 is fed to the upper surface of the movable guiding member 91 from the side of the curved portion 75a′, and hence the length from the curved portion 75a′ to the curved portion 75b′ is gradually reduced. Then, the FPC 75′ is deployed while retaining by the lower surface of the fixed guiding member 74′ and the upper surface of the movable guiding member 91 so as not to enter into the photographing optical path.

As a consequence, the lens barrel 112 according to the third embodiment achieves the advantages of the first and second embodiment, and since the FPC 75′ is retained by the upper surface of the movable guiding member 91, the FPC 75′ is prevented from being caught by respective mechanism parts therein.

The movable guiding members 51, 71, 91 according to the first to the third embodiment may be retained by the fixed guiding members 24, 74, 74′ so as to be capable of moving in the direction of the optical axis O.

Although the lens barrel is exemplified in the description of the above-described three embodiments, the invention can be applied to electronic devices connected to movable various members and various electric units and having a flexible circuit board involved in movement, for example, video cameras, by providing the above-described movable guiding member.

Although the flexible printed circuit board is used in the description of the present invention, it is not limited thereto, and a flat cable or a plurality of electric wires may be guided by the guiding member of the invention.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An electronic device comprising:
a movable member which is movable within the electronic device;
an electric wire member arranged in the electronic device and deformed in association with the movement of the movable member; and
a movable guiding member being movable independently of other member and guiding the electric wire member in association with the movement of the movable member.

2. The electronic device according to claim 1, wherein the electronic device is a lens barrel.

3. The electronic device according to claim 1, wherein the movable guiding member is provided on the movable member so as to be capable of moving with respect to each other.

4. The electronic device according to claim 3, wherein the electronic device is a lens barrel.

5. The electronic device according to claim 1, wherein the movable guiding member is provided on a fixed member located within the electronic device so as to be capable of moving.

6. The electronic device according to claim 5, wherein the electronic device is a lens barrel.

7. The electronic device according to claim 1, wherein an electric unit is provided within the electronic device, and the electric wire member electrically connects the electric unit and an external electric unit of the electronic device.

8. The electronic device according to claim 7, wherein the electronic device is a lens barrel.

9. The electronic device according to claim 1, wherein one end of the electric wire member is connected to the electric unit provided on the movable member.

10. The electronic device according to claim 9, wherein the electronic device is a lens barrel.

11. The electronic device according to claim 1, wherein the electric wire member is formed of a flexible printed electric board.

12. The electronic device according to claim 11, wherein the electronic device is a lens barrel.

13. The electronic device according to claim 1, further comprising a fixed guiding member fixed in parallel with the movable guiding member, and the electric wire member is guided between the movable guiding member and the fixed guiding member.

14. The electronic device according to claim 13, wherein the electronic device is a lens barrel.

15. The electronic device according to claim 1, wherein the movable guiding member moves in abutment with the movable member.

16. The electronic device according to claim 15, wherein the electronic device is a lens barrel.

17. The electronic device according to claim 1, wherein the movable guiding member moves in abutment with the electric wire member.

18. The electronic device according to claim 17, wherein the electronic device is a lens barrel.

19. The electronic device according to claim 1, further comprising an additional movable member being different from the movable member described above, and the movable guiding member moves by abutment between the additional movable member and the movable guiding member.

20. The electronic device according to claim 19, wherein the electronic device is a lens barrel.

21. A lens barrel comprising:
a lens system;
a fixed frame;
a movable frame being capable of relative movement with respect to the fixed frame in the direction of an optical axis of the lens system for at least one of focusing or zooming;
an elongated flexible member fixed directly or indirectly at one end to the fixed frame and fixed directly or indirectly at the other end to the movable frame, the flexible member being disposed in a bent state in the lens barrel, whereby the shape of the bent portion is changed by a relative movement of the fixed frame and the movable frame; and
a guiding member for guiding the shape of the bent portion of the flexible member, the guiding member being displaced relatively with respect to the movable frame when moving and guiding the flexible member so that no portion of the flexible member enters into a beam of the lens system.
